(19) United States
(12) Patent Application Publication
(10) Pub. No.: US 2008/0260983 A1
(43) Pub. Date: Oct. 23, 2008

(54) Irreversible Optical Recording Medium Comprising A Track with Low Raised Zones And Method For Using Same

(75) Inventors: Ludovic Poupinet, Sassenage (FR); Fabien Laulagnet, Grenoble (FR)

Correspondence Address: OLIFF & BERRIDGE, PLC, P.O. BOX 320850, ALEXANDRIA, VA, 22320-4850, US

(73) Assignees: COMMISSARIAT A L'ENERGIE ATOMIQUE, PARIS (FR); MPO INTERNATIONAL, AVERTON (FR)

(21) Appl. No.: 11/794,666

(22) PCT Filed: Jan. 25, 2006
(86) PCT No.: PCT/FR06/00169

§ 371 Date: Jul. 3, 2007

(30) Foreign Application Priority Data
Jan. 27, 2005 (FR) 0500863

(51) Int. Cl. B32B 3/30

(52) U.S. Cl. 428/64.4

(57) ABSTRACT

An irreversible optical recording medium comprises at least a substrate whereon is arranged at least a photosensitive layer comprising a structured front face destined to receive an optical radiation during data recording and/or reading operations. The medium also comprises a track comprising raised zones, having:
a height comprised between about 25 nm and about 35 nm for widths of raised zones comprised between 250 nm and 370 nm, and
a height comprised between a minimum value varying substantially linearly, in decreasing manner, from 25 nm to 32 nm, and a maximum value substantially of 35 nm, for widths of raised zones comprised between 200 nm and 250 nm.

### BACKGROUND OF THE INVENTION

The invention relates to an irreversible optical recording medium comprising at least a substrate whereon is arranged at least a photosensitive layer comprising a structured front face destined to receive an optical radiation during data recording and/or reading operations, with a track comprising raised zones.

The invention also relates to a method for using said support.

### STATE OF THE ART

Optical recording, for example on media of CD-R (Compact Disc-Recordable) and DVD-R (Digital Versatile Disc-Recordable) type, is most of the time performed by means of a layer of colorant material deposited on a plastic substrate and covered by a reflecting metal layer. However, irreversible optical recording technologies in colorant materials sometimes present high production costs, in particular with respect to the price of the colorants and to labour costs for the colorant handling steps.

Moreover, in writable optical supports, erasable or not, a groove in the form of a spiral, materialized by a raised track at the surface of the substrate, enables precise data writing and reading by means of a focusing control and tracking system, through said substrate. The pitch of the track is generally defined by the International disc format specifications. For example, DVDs present a track pitch equal to 740 nm whereas optical discs using a blue laser better known under the name of “Blu-Ray” discs present a track pitch of 320 nm. The track is also characterized by the depth and width of the groove.

Irreversible, i.e. non-erasable, recording media based on the use of colorants do however require a deep groove to be made, for example from 140 nm to 180 nm for a DVD-R disc. This large groove depth implies a relatively high substrate pressing time. Thus, the longer the substrate pressing time, the more the total time of the medium manufacturing cycle increases and the more the medium manufacturing yield decreases, which increases the production cost.

It is also possible to produce optical recording media using inorganic materials. Inorganic materials can present an advantage in terms of production cost and performance compared with organic colorants. Different methods exist to write in a layer made from inorganic material. The most widely studied irreversible technique consists in forming marks in the inorganic material by laser ablation. The presence of the mark results in a local decrease of the reflection of a laser beam at the surface of the disc. This reduced reflection is read with a weaker laser power. However, in the case of the DVD for example, the size of the marks is not compatible with the required storage density, in particular due to the presence of a pad of material around the marks.

Currently marketed recording media, based on the use of an inorganic material, generally present grooves of small depth, but these media are erasable. Moreover, they comprise a large number of thin layers, which increases their cost price. Lastly, the reflection of these discs is not compatible with that required by the International standards in force for non-erasable writable media.

### OBJECT OF THE INVENTION

One object of the invention is to provide an irreversible optical recording medium remedying the shortcomings of the prior art and presenting, more particularly, a relatively low production cost and a high production yield compared with media according to the prior art.

According to the invention, this object is achieved by the appended claims. More particularly, the medium is characterized in that the raised zones have:
a height comprised between about 25 nm and about 35 nm for widths of raised zones comprised between 250 nm and 370 nm, and
a height comprised substantially between a minimum value varying substantially linearly, in decreasing manner, from 25 nm to 32 nm, and a maximum value substantially of 35 nm, for widths of raised zones comprised between 200 nm and 250 nm.

It is a further object of the invention to provide a method for use of such a medium remedying the shortcomings of the prior art.

According to the invention, this object is achieved by the fact that the raised zones having:
a height comprised between about 25 nm and about 35 nm for widths of raised zones comprised between 250 nm and 370 nm, and
a height comprised substantially between a minimum value varying substantially linearly, in decreasing manner, from 25 nm to 32 nm, and a maximum value substantially of 35 nm, for widths of raised zones comprised between 200 nm and 250 nm,

data recording and reading are located at the level of the raised zones.

### BRIEF DESCRIPTION OF THE DRAWINGS

Other advantages and features will become more clearly apparent from the following description of particular embodiments of the invention given for non-restrictive example purposes only and represented in the accompanying drawings, in which:

FIG. 1 is a schematic representation, in cross-section, of a track arranged on the front face of a substrate and comprising two raised zones.

FIG. 2 schematically represents, in cross-section, a medium comprising the track according to FIG. 1.

FIG. 3 represents a reflectivity value of about 60% and normalized “Push-Pull” signal values of about 0.30 and of about 0.60, according to the height and width of the raised zones of a track.

### DESCRIPTION OF PARTICULAR EMBODIMENTS

An irreversible optical recording medium, preferably in the form of an optical disc or a chip card, comprises at least one substrate whereon at least one photosensitive layer is arranged. The photosensitive layer comprises a structured front face destined to receive an optical radiation during data recording and/or reading operations. In known manner, the irreversible optical recording medium can also comprise one or more additional layers disposed between the substrate and the photosensitive layer and/or on the front face of the photosensitive layer.

The photosensitive layer preferably comprises an inorganic material able to be locally deformed by the action of an optical radiation. The photosensitive layer also provides a sufficient reflection and partial absorption of the optical radiation light. The energy absorbed by the photosensitive layer therefore induces local heating in the layer which causes a local deformation of the latter. The local deformation can be in the form of a bubble or in the form of a hole and it forms a mark in the photosensitive layer. As the marks of the photosensitive layer are less reflecting than the non-deformed zones of the layer, it is then possible to read the medium by detecting the marks formed.

The length of the marks and the spaces between the latter thereby enable data to be encoded. It is also possible to vary the length of the marks by applying a specific modulation of the power of the optical radiation applied, said specific power modulation corresponding to a write strategy.

The shape of the marks is determined by the type of materials of the photosensitive layer. Thus, materials able to form holes, such as tellurium-base materials alloyed with antimony or with selenium, have been described in an article by M. Terao et al. (“Chalcogenide thin films for laser-beam recordings by thermal creation of holes”, J. Appl. Phys. 50(11), November 1979, pages 6881 to 6886).

However, to achieve larger data storage densities, it is preferable to give preference to materials able to form bubbles. Such materials generally have a relatively high melting point and they comprise at least one element that is easy to spray. In the case of writing by formation of bubbles, the composition of the photosensitive layer material is generally adapted so as to guarantee a quality of bubble formation compatible with a good standard deviation of the lengths of the marks titter) inscribed on the disc. Alloys having a sulphur, selenium, tellurium, arsenic, zinc, cadmium and phosphorous base can be used. For example, the photosensitive layer can comprise a zinc telluride (Zn—Te), zinc selenide (ZnSe), phosphate and zinc (PZn), arsenic and zinc (AsZn) or cadmium telluride (CdTe) alloy. For a layer made of Zn—Te alloy, the most suitable proportion is 65% atomic of zinc for 35% atomic of telluride, and the thickness of the layer is preferably comprised between 15 nm and 50 nm, and preferably equal to 40 nm.

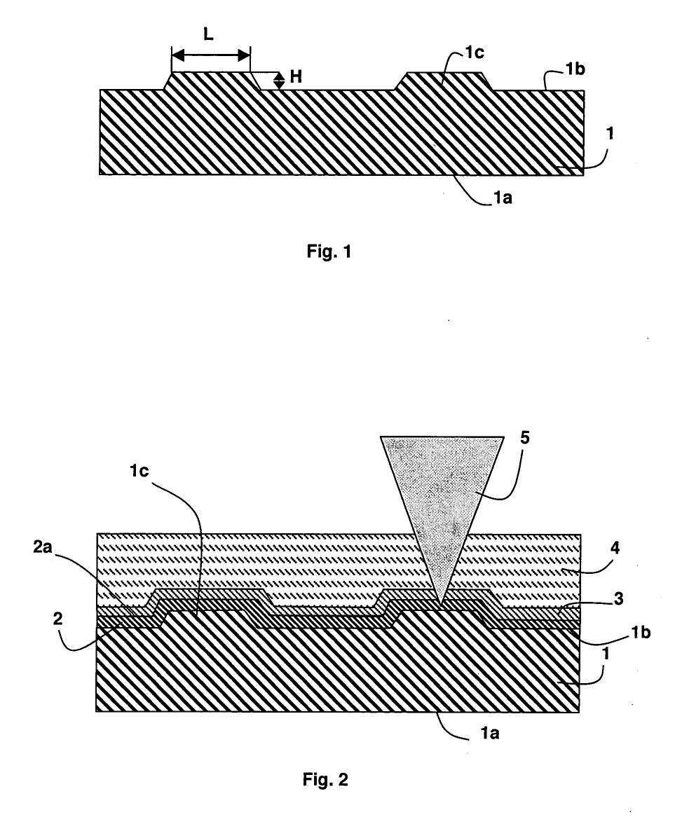

Precise write and read of the marks is generally performed in the irreversible optical recording medium by means of a focusing control and tracking system arranged in the recording medium. The track is for example achieved by structuring of the front face of the substrate. Thus, FIG. 1 represents, in conventional manner, a substrate 1 comprising a free rear face 1a and a structured front face 1b forming a track comprising raised zones 1c the set of which preferably forms a spiral. In FIG. 1, the front face 1b comprises two raised zones 1c, represented schematically in trapezoid form.

Generally, in recording media according to the prior art based on the use of colorants, the optical radiation or radiations enabling data write and/or read originate from the free rear face 1a of the substrate 1. They then pass through said substrate and focus locally at the level of a groove. Said groove, known according to the prior art and seen from the free rear face 1a, then corresponds to the set of raised zones 1c described in FIG. 1. Thus, the width L and height H of a raised zone 1c according to the invention correspond substantially to the depth and width of a groove of an optical recording medium according to the prior art.

According to the invention, the raised zones 1c have a height H comprised between about 25 nm and about 35 nm, for widths L of raised zones 1c comprised between 250 nm and 370 nm. For widths L of raised zones 1c comprised between 200 nm and 250 nm, the height H thereof is comprised between a minimum value varying substantially linearly, in decreasing manner, from 25 nm to 32 nm, and a maximum value substantially of 35 nm.

In addition, the raised zones 1c preferably have a maximum height Hₘₐₓ of 30 nm and a maximum width Lₘₐₓ of 370 nm.

Moreover, the width L of a raised zone is preferably defined as the width recognized by the control system. Such a width generally corresponds to the interface between the substrate and the photosensitive layer. Schematically, in FIG. 1, the width L of a raised zone 1c corresponds to the smaller of the two bases of the trapezoid representing said zone whereas the height H corresponds to the height of said trapezoid.

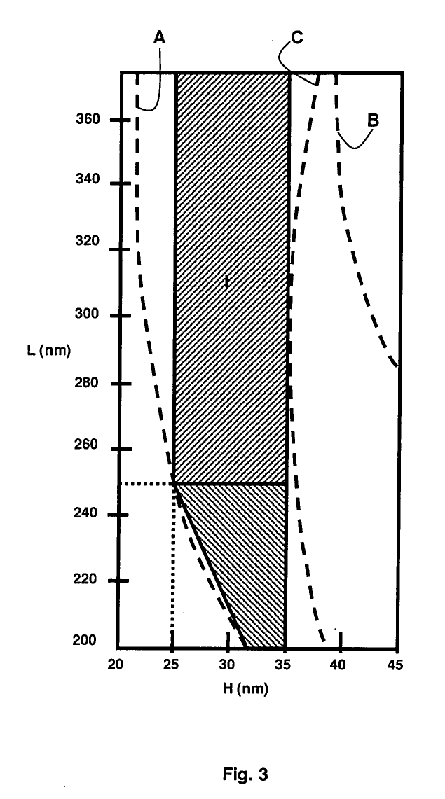

According to a particular embodiment represented in FIG. 2, an irreversible optical recording medium comprises the substrate 1 as represented in FIG. 1. A photosensitive layer 2 is deposited on the structured front face 1b of the substrate 1, preferably in uniform manner. The front face 2a of the photosensitive layer 2 is then structured in such a way that it comprises raised regions whereon data recording and reading are preferably located. The photosensitive layer thus deforms locally at the level of the raised regions disposed above the raised zones 1 c of the front face of the substrate.

A reflecting layer 3 preferably having a thickness less than or equal to 15 nanometers is preferably arranged on the front face 2a of the photosensitive layer 2. The reflecting layer is disposed between the photosensitive layer 2 and a protective layer 4 transparent to an optical radiation 5. The optical radiation 5 is designed to enable data recording and/or reading. It is preferably a focused power-modulated laser beam reaching a raised region of the photosensitive layer 2 disposed under a raised zone 1c of the track, after passing through the protective support 4 and the reflecting layer 3.

The reflecting layer 3 is designed to improve the optical properties of the photosensitive layer 2 and it is more particularly suitable when the photosensitive layer 2 reflects very little in a predetermined wavelength range. The reflecting layer 3 is for example suited to a zinc telluride photosensitive layer with a wavelength range of the optical radiation comprised between 630 nm and 650 nm. The reflecting layer 3 also enables the thermal behavior of the photosensitive layer 2 to be improved. It can be made of silver, gold, aluminium or copper.

The photosensitive layer 2, for example made of zinc telluride and designed to be deformed locally by the action of the optical radiation 5, has a thickness comprised between 20 nm and 30 nm, and it comprises a front face 2a whereby the optical radiation 5 is received, through the reflecting layer 3. The two layers, the photosensitive layer 2 and the reflecting layer 3, enable an inorganic stack to be formed that is able to obtain a strong initial reflection while at the same time preserving a good write sensitivity and a good contrast. The thickness of the inorganic stack is preferably substantially equal to the height of the raised zones 1c of the track.

The irreversible optical recording medium is not limited to the embodiment described above. The reflecting layer 3 can be replaced by a deformable layer, transparent to the optical radiation and non birefringent, as described in the International Application no.PCT/FR04/01897 filed on Jul. 16, 2004, under priority of a French Patent application no.FR0308875 filed on Jul. 21, 2003. The deformable layer is then disposed between the photosensitive layer and the protective support. The optical radiation thus passes through the deformable layer before reaching the structured front face of the photosensitive layer.

The deformable layer preferably has a thickness less than or equal to 200 μm, and more particularly comprised between 2 μm and 100 μm. It preferably comprises a polymer previously reticulated by a light radiation, such as polymers chosen among silicones or flexible acrylic-base polymers. The deformable layer is a layer that is able to follow the deformations of the photosensitive layer when write operations are performed on the photosensitive layer. The optical writing radiation passes through both the deformable layer and at least a part of the photosensitive layer, which enables deformations to be created in the deformable layer in addition to the raised zones created in the photosensitive layer.

Disposing a deformable layer on the front face of the photosensitive layer in particular fosters creation of precise marks in the photosensitive layer. Indeed, when the photosensitive layer deforms, the deformable layer has a deformation of the same type, accompanying the deformation of the photosensitive layer. The deformable layer thus limits widening of the write marks due in particular to the heat diffusion of the optical radiation when writing is performed. The deformable layer thus enables marks of better quality to be obtained.

Furthermore, a metal layer preferably having a thickness less than or equal to 15 nm can be disposed between the photosensitive layer and the deformable layer to improve the reflection of the photosensitive layer. Moreover, a transparent and very thin protective layer protecting against oxidation can also be disposed between said metal layer and the deformable layer. The recording medium can also comprise a semi-transparent additional photosensitive layer, possibly with a transparent additional deformable layer.

The substrate and protective layer used for an irreversible optical recording medium are preferably made of plastic, for example polycarbonate (PC) or polymethyl methacrylate (PMMA), and are achieved by moulding. The thickness of the substrates and the pitch of the track are variable according to the specifications imposed by the type of recording medium required. For example, for a DVD or for a HD-DVD (High Definition-DVD), the substrate has a thickness of 0.6 mm, whereas to produce a “Blu-Ray” disc the thickness of the substrate is 1.1 mm. In addition, according to current standards, the pitch of the substrate track is 0.74 μm for the DVD and 0.32 μm for the “Blu-Ray DVD” or HD-DVD. Moreover, the protective layer is non birefringent and preferably comprises flat front and rear faces. Its thickness is determined by the type of format of the required medium. Thus, for a DVD, the sum of the thicknesses of the protective layer and of the layers disposed between the protective layer and the substrate must be about 0.6 mm, whereas for a “Blu-Ray DVD” disc, the sum of the thicknesses must be about 100 μm.

Moreover, producing an irreversible optical recording medium comprising a track with raised zones having a small height facilitates pressing of the substrate and therefore enables shorter production cycle times to be achieved. This then results in a gain in yield and a reduction of the production cost.

Furthermore, the height H and width L of the raised zones are advantageously chosen in such a way as to preserve:
a minimum reflection level of the disc before writing,
and correct tracking of the disc, before and after writing.

Indeed, according to the International standard ECMA 349, the reflectivity of the recording disc, before and after writing, must be comprised between 45% and 85%, whereas the normalized “Push-Pull” signal enabling measurement of the ease with which a recording medium will be able to track, must be comprised between 0.30 and 0.60.

In FIG. 3, the curves A and B respectively represent normalized “Push-Pull” signal values of 0.30 and 0.60, according to the height and width of the raised zones whereas the layer C represents a reflectivity value equal to 45%.

It can thus be noted that for a track comprising raised zones with a width L comprised between 250 nm and 370 nm and a height H comprised between 25 nm and 35 nm, the recording medium is situated in a rectangular zone I comprised between the curves A and C. The medium thus has a reflectivity greater than or equal to 45% (curve C) and the normalized “Push-Pull” signal is well comprised between 0.30 and 0.60.

For raised zones having a width L comprised between 250 nm and 370 nm and a height H comprised between a minimum value varying linearly from 25 nm to 32 nm, in decreasing manner according to the width and a maximum value of 35 nm, the recording medium also complies with the specifications of the ECMA 349 standard in terms of reflectivity and tracking.

1. An Irreversible optical recording medium comprising at least a substrate whereon is arranged at least a photosensitive layer comprising a structured front face destined to receive an optical radiation during data recording and/or reading operations, with a track comprising raised zones, wherein the raised zones have:
a height comprised between about 25 nm and about 35 nm for widths of raised zones comprised between 250 nm and 370 nm, and
a height comprised between a minimum value varying substantially linearly, in decreasing manner, from 25 nm to 32 nm, and a maximum value substantially of 35 nm, for widths of raised zones comprised between 200 nm and 250 nm.

2. The medium according to claim 1, wherein the raised zones have a maximum height of 30 nm and a maximum width of 370 nm.

3. The medium according to claim 1, wherein a deformable layer, transparent to the optical radiation, is disposed on the front face of the photosensitive layers.

4. The medium according to claim 1, wherein the photosensitive layer comprises an inorganic material able to be locally deformed by the action of the optical radiation.

5. The medium according to claim 1, wherein the substrate comprising a free rear face and a front face whereon the photosensitive layer is disposed, the front face of the substrate is provided with the track comprising the raised zones.

6. A method for use of an irreversible optical recording medium according to claim 1, wherein the raised zones have:
a height comprised between about 25 nm and about 35 nm for widths of raised zones comprised between 250 nm and 370 nm, and
a height comprised substantially between a minimum value varying substantially linearly, in decreasing manner, from 25 nm to 32 nm, and a maximum value substantially of 35 nm, for widths of raised zones comprised between 200 nm and 250 nm,
data recording and reading being located at the level of the raised zones.

7. The method for use of an irreversible optical recording medium according to claim 6, wherein data recording is achieved by local deformation of the photosensitive layer in the form of a bubble at the level of at least one raised zone.
